(19) United States
(12) Patent Application Publication
(10) Pub. No.: US 2017/0122150 A1
(43) Pub. Date: May 4, 2017

(54) Automatic Engine Pre-Lube

(71) Applicant: TAS Distributing Company, Inc., Peoria, IL (US)

(72) Inventor: Loran Sutton, East Peoria, IL (US)

(21) Appl. No.: 15/337,995

(22) Filed: Oct. 28, 2016

Related U.S. Application Data
(60) Provisional application No. 62/247,620, filed on Oct. 28, 2015.

(51) Int. Cl. F01M 5/02; F02N 11/08; F02P 19/02

(52) U.S. Cl. CPC F01M 5/025; F02P 19/021; F02N 11/0829; F02N 11/084; F01M 2250/60

(57) ABSTRACT

An automatic engine start/stop system and method which are compatible with recent engine requirements of a pre-lube period before engine crank, is disclosed. A temp-start controller is used to read inputs such as ambient temperature, oil temperature and engine RPMs, to determine proper conditions for engine cranking. A pre-lube pump is activated by the controller for up to 45 seconds, or a desired period of time, before engine crank. A glow plug pre-heating step may be performed as well, if necessary.

### RELATED APPLICATIONS

The present application claims the filing priority of U.S. Provisional Application No. 62/247,620, titled “Automatic Engine Pre-Lube” and filed on Oct. 28, 2015. The '620 application is hereby incorporated by reference.

### TECHNICAL FIELD OF THE INVENTION

The present application relates in general to truck engine control. More specifically, the invention relates to a system and method for automatically starting and stopping a diesel engine with a pre-lube requirement. The system and method disclosed conserve fuel while providing temperature control of a truck sleeper unit and maintaining the engine in a ready-to-start condition.

### BACKGROUND OF THE INVENTION

Systems and methods for automatically starting and stopping a truck engine to conserve fuel while providing temperature control of a truck sleeper unit, and maintaining the engine in a ready-to-start condition, are known in the art. However, a new feature of OE engine start sequence software is a pre-crank time period for the engine pre-lube.

The engine pre-lube sequence occurs when the key is placed in the start mode, but instead of the engine cranking, a pre-lube pump is activated for up to 45 seconds. When the engine software determines that the pre-lube is sufficient, the starter is engaged to start the engine.

This added feature in the OE software is problematic for current automatic start systems. However, the present invention solves this problem to allow for automatic start and stop of a truck engine to conserve fuel and maintain the engine in a ready-to-start condition.

These and other problems are addressed by the present device and methods to provide a system with numerous advantages in operation and effectiveness.

### SUMMARY OF THE INVENTION

There is disclosed herein an improved automatic engine start/stop system and method for use in a vehicle with pre-lube requirements. The embodiments of the system and method are believed to avoid disadvantages of prior devices while affording additional structural and operating advantages.

Generally speaking, the system comprises a temp-start controller coupled to an engine control unit and an engine ignition switch, wherein the engine control unit is coupled to a required pre-lube pump. The temp-start controller automatically activates at a requisite time the pre-lube pump via the engine control unit before engine crank.

Preferably, the pre-lube pump is activated for up to 45 seconds before one of either engine crank or an abort start. The system may further comprise a plurality of signals to the temp-start controller to input engine oil temperature, ambient temperature, and engine RPMs.

In a specific embodiment, the system comprises an output signal from the temp-start controller to initiate pre-heating of a glow plug.

In an embodiment of the preferred method for automatically starting an engine, the steps include inputting an ambient temperature measurement to a temp-start controller, inputting an oil temperature measurement to the temp-start controller, inputting a battery voltage to the temp-start controller, inputting an engine RPM measurement to the temp-start controller, initiating engine ignition, activating a starter for pre-lube for a period of time, cranking the engine until start or a second period of time, whichever occurs first, and aborting engine start if second period of time is reached.

In a specific embodiment, the pre-lube period of time is up to 45 seconds. The method may also include the step of pre-heating a glow plug before cranking the engine.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated. The accompanying drawings are considered part of the specification and disclosure of the present application.

FIG. 1 is a flow chart illustrating a prior automatic start sequencing;

FIG. 2 is a flow chart illustrating an automatic start sequencing of an embodiment of the current system;

FIG. 3 is a schematic of an embodiment of the pre-lube automatic start/stop system; and

FIG. 4 is a chart illustrating time savings of an automatic start/stop system.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

U.S. Pat. Nos. 5,072,703, 5,222,469 and 5,317,998 provide background details on automatic start/stop systems and operations which should be understood by those of skill in the art. The relevant details of the '703, '469 and '998 patents, as they may assist in the understanding of the features and advantages of an embodiment of the present automatic start/stop system and methods, are hereby incorporated by reference.

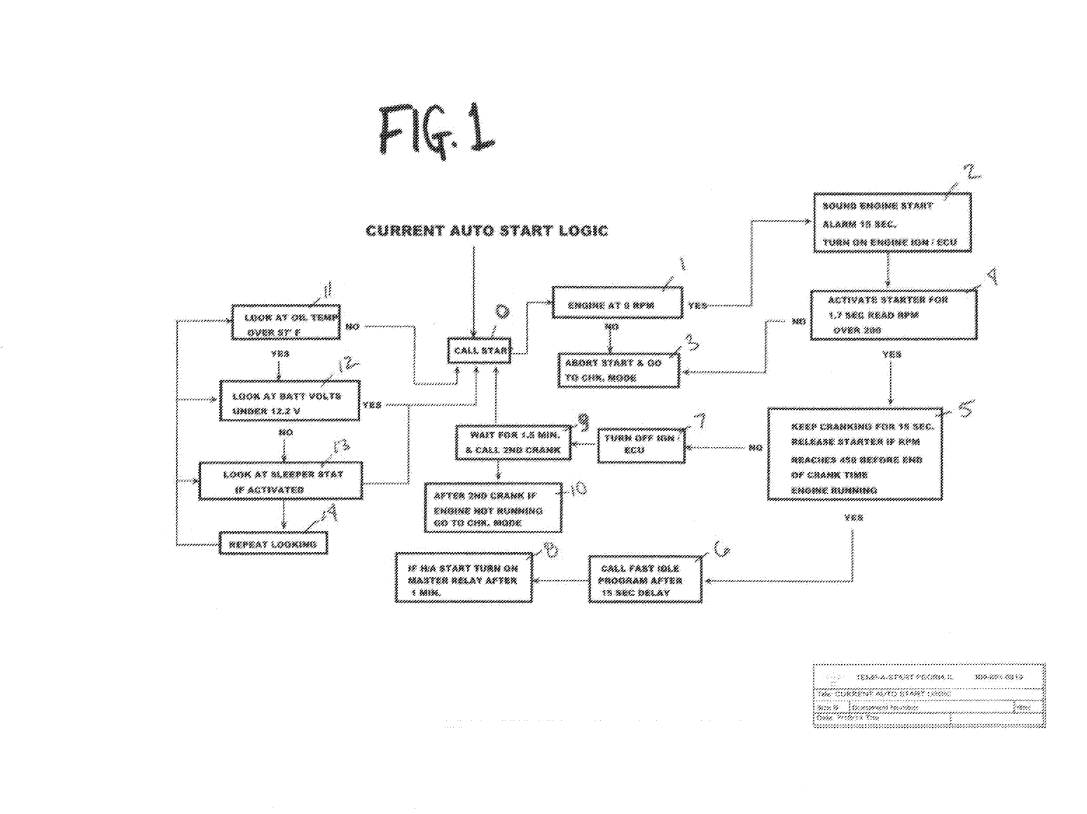

Beginning with an analysis of the prior art system illustrated in FIG. 1, an automatic start sequence, it is clear the current system is not equipped to address a pre-lube requirement of a truck engine. The ignition cycle begins at box 1 where a positive zero (0) engine RPMs determination leads to a 15 second engine start alarm and engine ignition [box 2], then to activation of the starter and an engine RPM read of over 200 [box 4]. A negative determination at boxes 1 or 4 results in an abort start [box 3]. The use of such an automatic start/stop device will fail if installed on a truck having an engine with a pre-lube requirement as it neglects to provide time for the pre-lube.

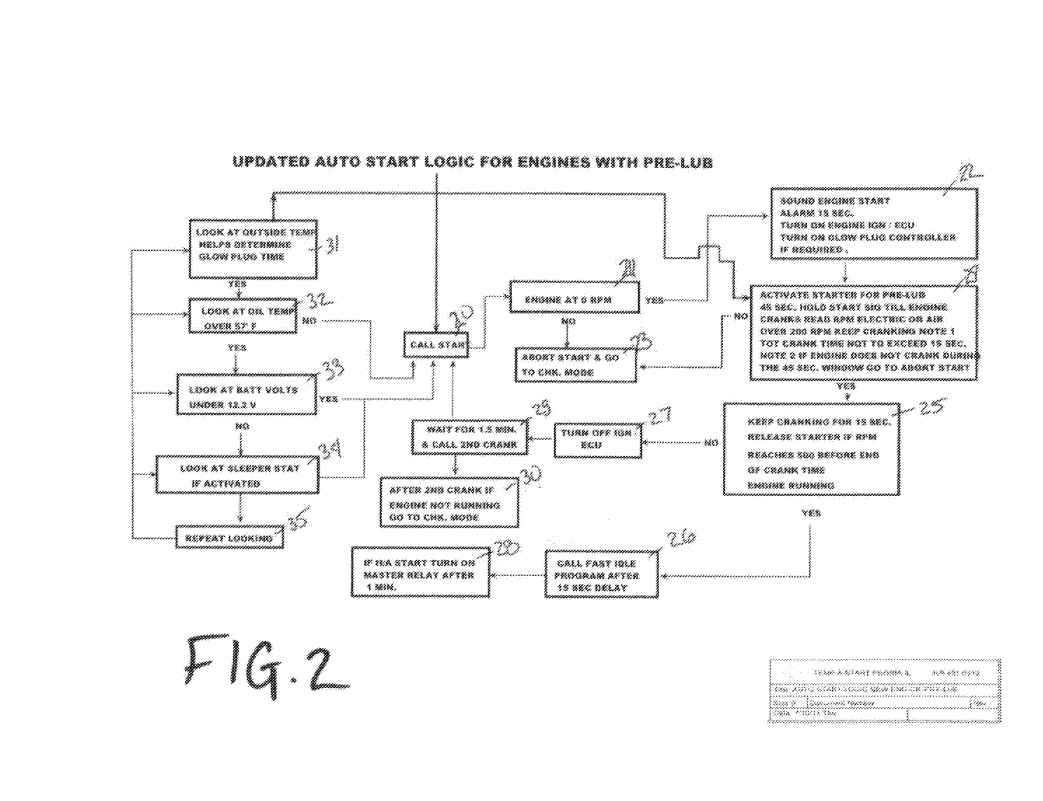

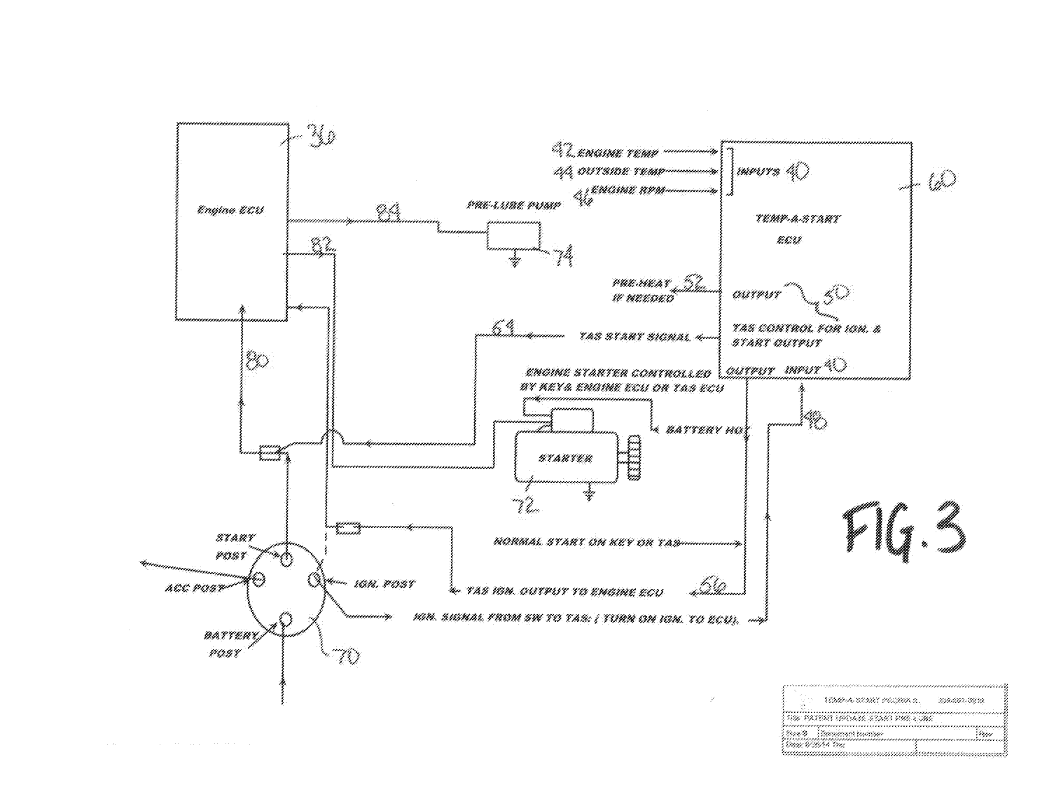

In contrast, the system and method illustrated in FIGS. 2 and 3 are capable of activating a starter for pre-lube. The start logic of FIG. 2 begins much as the prior art of FIG. 1, with confirmation of zero (0) engine RPMs [box 21]. Box 22 then shows a 15 second alarm with engine ignition and glow plug controller turned on, as necessary. However, the pre-lube step is activated at box 24 where engine cranking continues for no more than 45 seconds before abort start at box 23. While most of the remaining boxes of FIG. 2 correspond with those of FIG. 1, there is one extra step in box 31 which checks ambient temperature as a means for determining glow plug time. This last step addresses pre-heat requirements for glow plugs, as needed.

Referring to FIG. 3, a schematic of an embodiment of an automatic engine starter with pre-lube capability is shown. The illustrated system includes engine control unit (ECU) 36, Temp-Start ECU 60, ignition switch 70, starter 72, and pre-lube pump 74.

The Temp-Start ECU 60 includes capabilities for inputs 40 and outputs 50. The inputs 40 are generally provided by sensors (not shown) and include engine oil temperature 42, ambient (i.e., outside) temperature 44, engine RPMs 46, and engine start request/ignition key on 48. The outputs 50 include a glow plug pre-heat request 52, if needed, start signal 54 to engine ECU 36, and ignition output 56 to engine ECU 36.

The engine ECU 36 includes inputs from the outputs 54 and 56 of Temp-Start ECU 60 as well as start request 80. Outputs from the engine ECU 36 include a signal 82 to starter 72 and signal 84 to pre-lube pump 74.

The preferred sequence begins by looking at the outside temperature to determine the pre-heat time for a glow plug, if needed. The system also looks at other conditions including engine oil temp—to determine if it is over 57° F.—battery voltage (over 12.2 volts) and sleeper status, if activated. The “look” sequence is repeated until proper conditions are achieved or the sequence is aborted.

As described, the starter 72 is also activated for the pre-lube step for 45 seconds. When properly lubed, the engine will crank. Otherwise, the system will abort the start sequence. This is a very important step in new OE engines having pre-lube requirements. No other automatic start system will work.

To achieve the objectives of the present invention, the preferred disclosed system uses the Temp-Start ECU 60 to control ignition signal to the ECU 36, starter pre-lube and crank signal. The Temp-Start ECU 60 is able to automatically start and shut down the engine for improved efficiency.

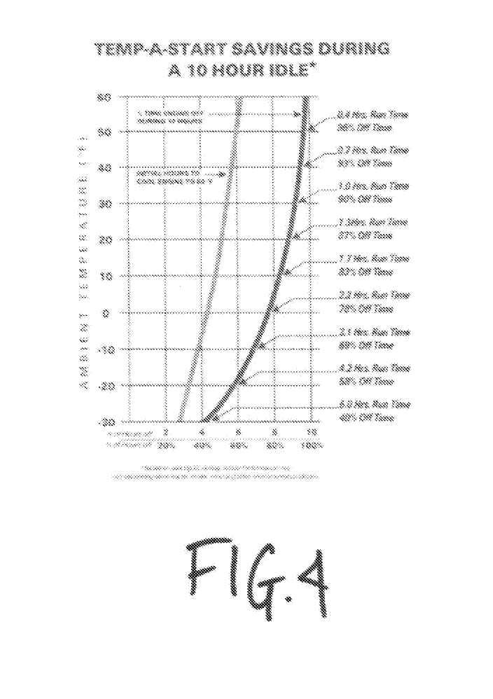

An advantage of the automatic start/stop control of the present system and method is illustrated in FIG. 4. This chart illustrates the automatic start/stop system over a 10 hour idle period. For example, at 30° F. ambient, the 10 hour idle yields nine (9) hours of off time and only 1 hour of run time, resulting in a significant efficiency savings. Even at an ambient temp of −20° F., run time for a 10 hour idle is limited to 4.2 hours.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An automatic start/stop system compatible with engines requiring a pre-lube sequence, the system comprising:
a temp-start controller coupled to an engine control unit and an engine ignition switch, wherein the engine control unit is coupled to a pre-lube pump;
wherein the temp-start controller automatically activates at a requisite time the pre-lube pump via the engine control unit before engine crank.

2. The system of claim 1, wherein the pre-lube pump is activated for up to 45 seconds before one of either engine crank or an abort start.

3. The system of claim 1, further comprising a plurality of signals to the temp-start controller to input engine oil temperature, ambient temperature, and engine RPMs.

4. The system of claim 1, further comprising an output signal from the temp-start controller to initiate pre-heating of a glow plug.

5. The system of claim 3, further comprising an output signal from the temp-start controller to initiate pre-heating of a glow plug.

6. A method for automatically starting an engine comprising the steps of:
initiating engine ignition;
activating a starter for pre-lube for a period of time; then
cranking the engine to start.

7. The method of claim 6, further comprising the step of checking engine oil temperature and battery voltage are within desired ranges.

8. The method of claim 7, further comprising the step of checking ambient temperature to determine a glow plug pre-heat requirement.

9. The method of claim 6, further comprising the step of checking ambient temperature to determine a glow plug pre-heat requirement.

10. The method of claim 6, wherein the pre-lube period of time is up to 45 seconds.

11. The method of claim 8, further comprising the step of pre-heating a glow plug before cranking the engine.

12. The method of claim 9, further comprising the step of pre-heating a glow plug before cranking the engine.

13. A method for automatically starting an engine comprising the steps of:
inputting an ambient temperature measurement to a temp-start controller;
inputting an oil temperature measurement to the temp-start controller;
inputting a battery voltage to the temp-start controller;
inputting an engine RPM measurement to the temp-start controller;
initiating engine ignition;
activating a starter for pre-lube for a period of time;
cranking the engine until start or a second period of time, whichever occurs first;
aborting engine start if second period of time is reached.

14. The method of claim 13, wherein the pre-lube period of time is up to 45 seconds.

15. The method of claim 13, further comprising the step of pre-heating a glow plug before cranking the engine.
